(19) United States
(12) Patent Application Publication
(10) Pub. No.: US 2010/0064219 A1
(43) Pub. Date: Mar. 11, 2010

(54) Network Hosted Media Production Systems and Methods

(76) Inventors: Ron Gabrisko, Phoenix, AZ (US); James Todd Smith, Phoenix, AZ (US); Piers Lingle, Phoenix, AZ (US); Jason Barrett, Phoenix, AZ (US); Claudine Joseph, Phoenix, AZ (US); Nicholas Miller, Phoenix, AZ (US); Mark Lowe, Phoenix, AZ (US); Chris Lam, Phoenix, AZ (US); Thomas Rolfs, Phoenix, AZ (US); Glen Marchese, Phoenix, AZ (US)

Correspondence Address: COURTNEY STANIFORD & GREGORY LLP, 10001 N. De Anza Blvd., Suite 300, Cupertino, CA, 95014, US

(21) Appl. No.: 12/510,892

(22) Filed: Jul. 28, 2009

Related U.S. Application Data
(60) Provisional application No. 61/086,562, filed on Aug. 6, 2008.

(51) Int. Cl. G06F 3/01; G06F 17/00

(52) U.S. Cl. 715/716; 700/94

(57) ABSTRACT

Embodiments provide systems and methods to create new media. Collaborating users can create new media using a network hosted media production functionality of an embodiment. In one embodiment, a network hosted media production system can be used to create new media, wherein the system includes a sound library component, a video component, a live input component, a sequencer component, and a synchronization component.

### RELATED APPLICATION

This application claims the benefit of U.S. patent application Ser. No. 61/086,562, filed Aug. 6, 2008.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BRIEF DESCRIPTION OF THE DRAWINGS

FIGS. 1A and 1B show a block diagram of an exemplary system including a network hosted media production studio, under an embodiment.

FIG. 2A is a block diagram of an exemplary user interface provided by a producer studio component, under an embodiment.

FIG. 2B is an exemplary user interface provided by a producer studio component, under an embodiment.

FIG. 3 is a block diagram of an exemplary media production system, under an embodiment.

FIG. 4 depicts an exemplary sound library component interface of a media production system, under an embodiment.

FIGS. 5A-5C depict exemplary features of a video component interface, under an embodiment.

FIG. 6A-6B depict components of an exemplary visual sequencer interface 600 including a number of interactive control components and features, under an embodiment.

FIG. 7 depicts an exemplary sequencer time interface, under an embodiment.

FIGS. 8A-8D depict a number of synchronization processes, under various embodiments.

FIG. 9 depicts exemplary plugin microphone components, under an embodiment.

### DETAILED DESCRIPTION

Embodiments provide systems and methods to create new media. Collaborating users can create new media using a network hosted media production functionality of an embodiment. In one embodiment, a network hosted media production system can be used to create new media, wherein the system includes a sound library component, a video component, a live input component, a sequencer component, and a synchronization component.

In the following description, numerous specific details are introduced to provide a thorough understanding of, and enabling description for, the systems and methods described. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

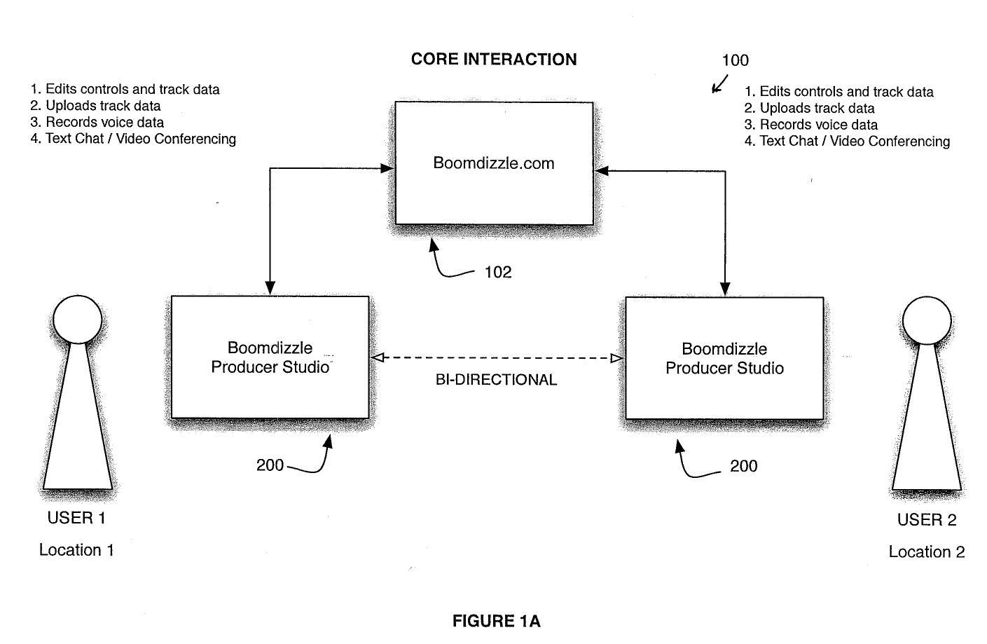

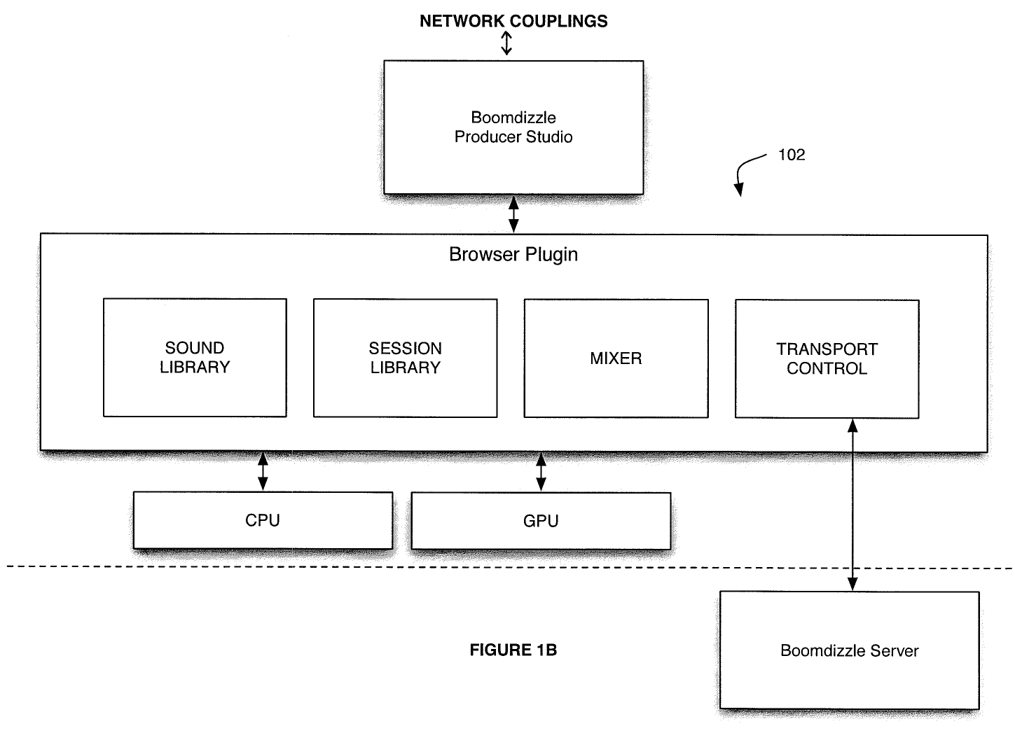

FIGS. 1A and 1B show a block diagram of a system 100 including a network hosted media production studio 102, under an embodiment. The media production studio 102, also referred to herein as the Boomdizzle Producer Studio (BPS) 102, includes one or more applications or components hosted at a remote site on at least one processor-based device (e.g., server, personal computer (PC), etc.). The BPS 102 is accessed by users via a network coupling or connection, web portal, and/or website (e.g., boomdizzle.com) and allows users to create new media and to collaborate with other users to create new media. The media can include music and movies, but is not so limited. The BPS 102 provides a collaborative tool to create “rough” or “offline” mixes (similar to a four track cassette recorder), and embodiments also include professional editing and effects tools that allow users to sequence and finish completed tracks.

With reference to FIG. 1B, the BPS 102 of an embodiment includes a shared control and communication component, a mixer component, a transport control component, a sound library, and a session library. The components of the BPS 102 are hosted or run under a processor-based device at one or more remote sites, and each component is described in detail below.

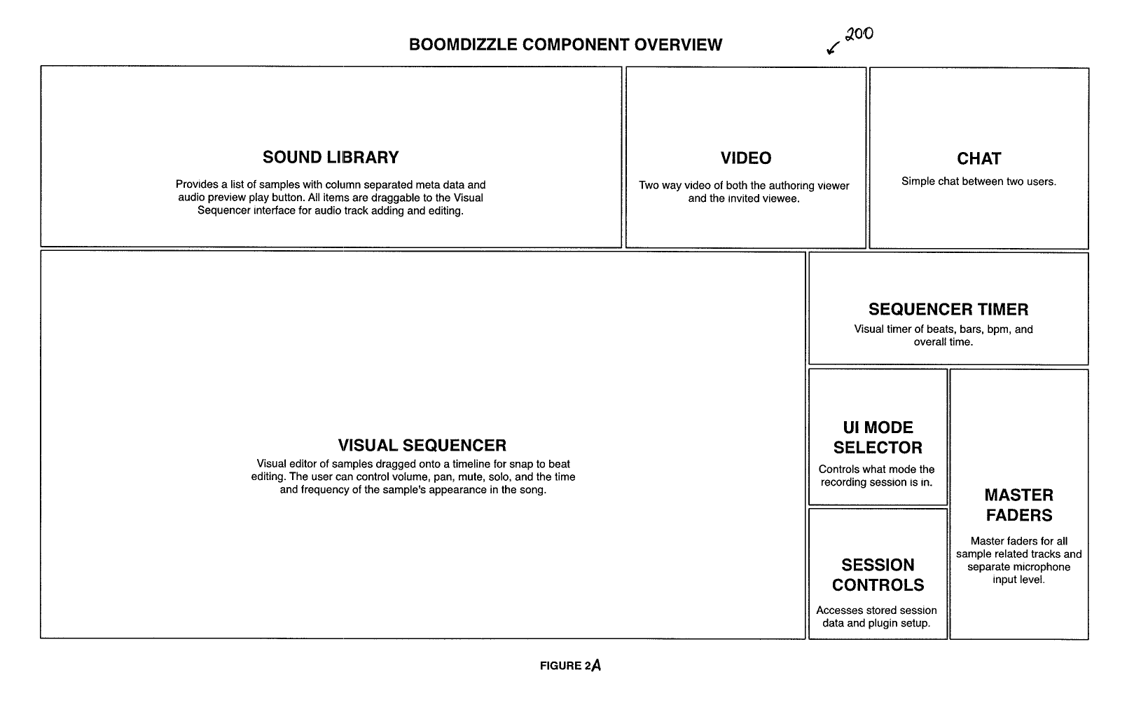

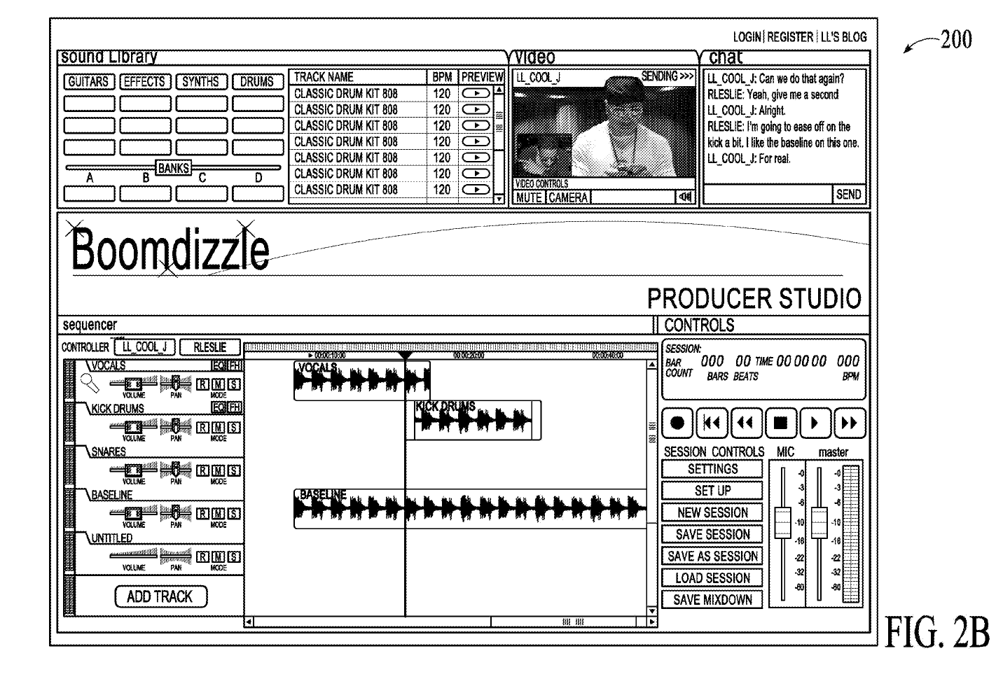

The shared control and communication component includes an interface 200. FIG. 2A is a block diagram of an exemplary user interface 200 provided by a producer studio component, under an embodiment. FIG. 2B is an example user interface 200 provided by the BPS 102, under an embodiment. The interface 200, which allows a user to invite another user to the interface 200, provides shared command of interface controls; users can also audio/video conference and text chat with each other via the interface 200. The shared control and communication component includes an invite button that launches a dialogue box with a field for an email address. Upon initiation or activation, an email is sent with an invite link that loads the shared Producer Studio when clicked. If the recipient is not already logged-into the BPS 102, they are prompted to do so before accessing the BPS 102. The shared control and communication component includes a scrolling text chat interface with a submission field and button, and also includes a picture-in-picture video chat box with an on/off switch to enable/disable audio/video communication.

The mixer component of an embodiment includes a 30-track mixer by which users can assign a sample from the Sound Library to a track. While this example embodiment includes a 30-track mixer, alternative embodiments can include an N-track mixer, where N is any number. Each track includes controls like, for example, volume, pan, mute, solo, and controls to loop the sample, to name a few. The vocal track is used for samples recorded directly from a microphone connected to the user's computer into the BPS 102.

The mixer component of an embodiment includes controls that allow a sample from the sound library to be assigned to any track and set to play once immediately or loop. Each track includes one or more of the following controls, but the embodiment is not so limited: volume slider; mute button; solo button; pan knob; signal LED; loop button (on/off); loop length knob ( 1/16 th, ⅛ th, ¼ th, ½, 1, 2, 4); offset knob ( 1/16 th, ⅛th, ¼ th, ½, 1, 2, 4); assigned sample name; and, button to remove assigned sample.

The vocal track of an embodiment is reserved for live audio recorded from a microphone attached to the user's computer. This vocal track has a microphone icon or button that launches a dialogue box which includes one or more of the following, but the embodiment is not so limited: a text field to title the take; a pre-roll bar length with up/down buttons (1-32) used to determine or control how long the four tracks will play before the microphone begins recording; a record button; and a stop button. Selection or activation of the record button in the record dialogue interface causes one or more of the following to occur: the take title text becomes static (no field); the record button turns into a stop button; the four tracks begin playing immediately; if the user has selected any pre-roll, a countdown is shown queuing the user as to when the recording will begin. Selection or activation of the stop button in the record dialogue interface causes one or more of the following to occur: the take title text becomes editable again; a play button is displayed to playback the take against the four tracks; a re-record button is displayed to scrap the recording and start again; a cancel button is displayed to exit the record dialogue without saving; a save button is displayed to save the sample and assign it to track 5 (if a sample has previously been assigned to track 5, it is replaced, but the replaced sample remains available from the sample library.

The transport control component includes a master transport control provided to allow a user to play, pause, rewind, fast forward and return to the beginning of the track. When in a shared session, the transport control drives both users' playback. A control is also provided to set the BPM of the song along with time and beat readouts. The transport control of an embodiment includes one or more of the following, but is not so limited: a return button (back to first beat); a rewind button; a play/pause button; a fast forward button; a track time display (e.g., 01:24:08); a bar count display (e.g., 24:03:16); a tempo (e.g., beats per minute (BPM)) count display (e.g., 120) with up/down buttons to adjust BPM within one or more prespecified ranges (e.g., in a range of 95-125); a headphones mode button (e.g., when off, video conferencing audio is muted anytime mixer is playing); a master volume control; a master mute button for mixer audio; and, a master volume control and mute button for video chat audio.

The BPS 102 includes a sound library that comes pre-loaded with sample sounds, including drum, bass, lead and FX, from which users can create songs. Users also have the ability to upload their own sound samples to this library which will then be accessible on all future visits to the BPS 102. The sound library of an embodiment comprises a number of libraries of samples. An embodiment of the BPS 102 includes six sound libraries as follows, but the embodiment is not so limited: Drums, Bass, Leads, FX, Uploads (audio files uploaded by user), and Takes (audio files recorded by user). Each library will hold at least 5-10 samples. The sound library provides a play button for each sample by which users can preview the sound. A user can assign a sample to a track by dragging it from the library to a track in the mixer.

The sound library of an embodiment include an upload button, the activation of which launches a dialogue box where a user can upload their own audio file to be added to the Uploads section of the Sample Library. This dialogue includes a browse button to select the file locally, and a title field to name the file and upload/cancel buttons. Upon completion of file uploading, the file is encoded and added to an upload section of the sample library.

The BPS 102 of an embodiment includes a session library. Users have the ability to save a BPS session to the session library or load a previously saved session into the BPS 102. This process allows the user to archive the exact BPS settings at the time they are saved. The session library of an embodiment includes a save button that launches a dialogue allowing the user to title and save the session. The session library of an embodiment includes a close button that launches a dialogue asking the user if they want to save the session or close without saving. A saved session allows the studio to be launched again in the future with the same track configuration (assigned sample, volume, pan, etc.). A session invitee also has access to a session if they save it. When two users work on a session, both have access to the session's settings. In one embodiment, only uploaded samples are accessible in the sample library.

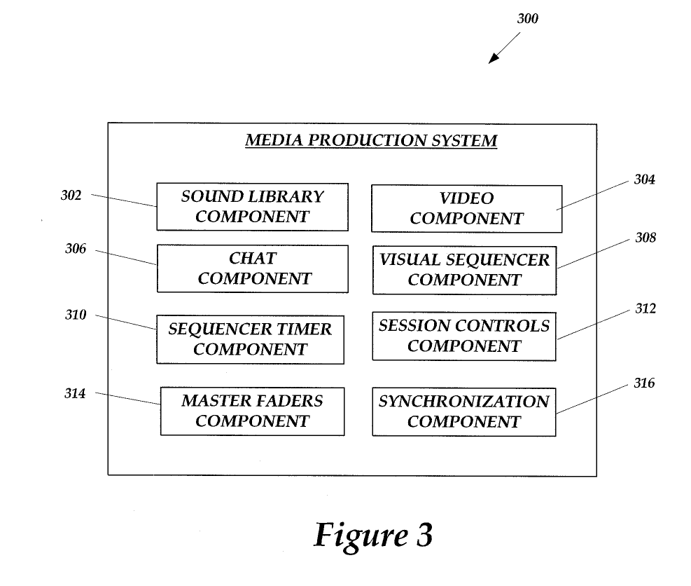

FIG. 3 is a block diagram of a media production system (MPS) 300, under an embodiment. Components of the MPS 300 can be configured to create new media projects including creating new media and/or collaborating with other media producers to create new media, but the components are not so limited. For example, collaborating users can use functionality of the MPS 300 to collectively contribute and create music, movies, and other creative works. In one embodiment, the MPS 300 includes one or more applications or components hosted at a remote site on at least one processor-based device including memory (e.g., server, personal computer (PC), etc.). The MPS 300 can be accessed by users via a network coupling or connection, web portal, and/or website (e.g., boomdizzle.com). In an alternative embodiment, certain components of the MPS 300 can be included on a user's computing device whereas other components can be hosted at one or more remote sites.

As shown in FIG. 3, components of the MPS of an embodiment include, but are not limited to: a sound library component 302, a video component 304, a chat component 306, a visual sequencer component 308, a sequence timer component 310, a session controls component 312, a master faders component 314, and/or a synchronization component 316. In alternative embodiment, one or more components can be combined or further subdivided. Additionally, components of the MPS 300 can be combined and or included with components of other systems. Other embodiments are available.

In an embodiment, the sound library component 302 can be used to provide a list of media samples including column separated sample metadata and/or audio preview capability. Items included with the sound library component 302 are draggable to the visual sequencer component 308 for audio track adding, editing, and/or other media operations, as described further below.

In one embodiment, the sound library component 302 includes functions, application programming interfaces (APIs), and/or other functionality/features including, but not limited to abilities of: starting a process of prompting a user for selecting a file for upload (e.g., uploadImage( ) from local hard drive or other storage); returning list of samples as categorized by a bank metaphor (e.g., getSoundList( )to return name, channel count, tempo (beats per minute (bpm)), and/or a uniform resource locator (URL) for instant preview); toggling a play button to provide a pause icon or beginning to play a selected sample (e.g., playSample( )); and/or returning a list of banks and/or sound categories to be rendered as button names (e.g., getBankList( )).

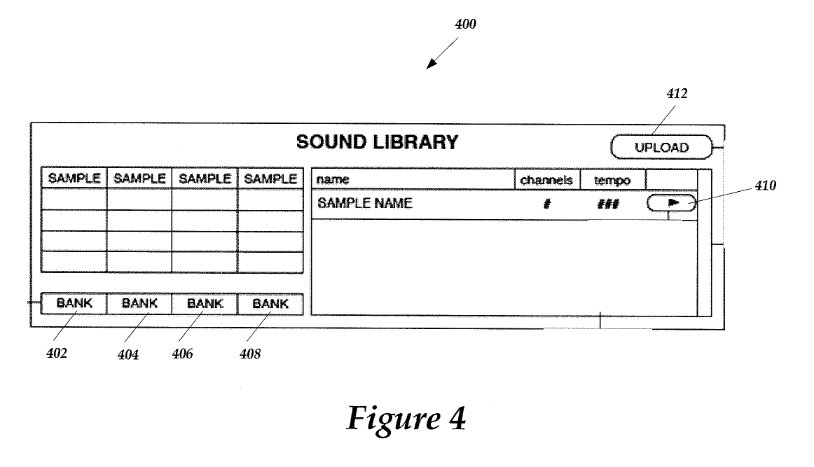

FIG. 4 depicts a sound library component interface 400 of a media production system, under an embodiment. In one embodiment, the interface 400 can be used to access samples of one or more sound libraries to create songs and other audible compositions, including movie or video audio tracks. For example, sound libraries can be pre-loaded and customized with sample sounds, including drum, bass, lead and FX, etc. In one embodiment, the production system can include six sound libraries, but is not so limited: Drum library, Bass library, Leads library, FX library, Upload library (uploaded audio files), and Takes library (recorded audio files). A user can use the interface 400 to review samples and sample portions. A user can assign a sample to a track by dragging it from the library to a track in a sequencer component or other mixing component.

As shown in FIG. 4, the interface 400 includes a number of sound bank selectors 402-408. A user can select or more of the sound bank selectors 402-408 to invoke one or more filters. For example, bank selector 402 can be used to invoke a filter on one or more viewable samples in the interface 400. In various embodiments, each bank selector can be associated with a programmable or default filter, wherein particular filters can be associated with one or more of the banks or filter types can be shared across the banks.

A sample list can be provided and presented in the interface 400 based in part on a selected bank (e.g., clicking or toggling one or more of the sound bank selectors 402-408). In one embodiment, based in part on the selected bank, a sound library component operates to load a list of samples from dedicated storage or memory. For example, an API can be used to retrieve samples from a backend database or other store to present samples and sample parameters in the interface 400. In an embodiment, the sample parameters include, but are not limited to: a track name, a channel count, and/or tempo (bpm). In one embodiment, the interface 400 can include a play preview button 410 to allow enable sample previews without having to move the sample to a sequencer interface.

As shown in FIG. 4, the exemplary interface 400 of an embodiment includes an upload button 412. Activating the upload button 412 operates to launch a dialogue box enabling a user to upload an audio file to be added to an upload section of a sample library. For example, the dialogue can include a browse button to select local files, a title field to name the file, and upload/cancel buttons. In one embodiment, the dialogue can be used to upload samples to a server, wherein samples are available for use by selecting a bank selector of the interface 400 corresponding to “Custom” samples. Upon completion of file uploading, the file or sample is encoded and added to the sample library.

Referring again to FIG. 3, the video component 304 of an embodiment provides video of an authoring viewer and one or more invited parties or viewees. For example, the video component 304 can be configured to provide two-way video to/from an authoring viewer and an invited viewee. The video component 304 of one embodiment provides, but is not limited to: a status indicator to inform a user of video component operations; a mic button which allows the user to toggle “on” an “off” microphone input to one or more invited parties; a cam button which allows the user to toggle “on” and “off” camera video input to one or more invited parties, and local capture; a volume slider to control incoming sound level(s) of invited guest(s); picture-in-picture (PIP) of one or more invited guests where an authoring sender can be captured in one configurable window or interface (e.g., smaller image) and an invited visitor can be captured in a different configurable window (e.g., larger image).

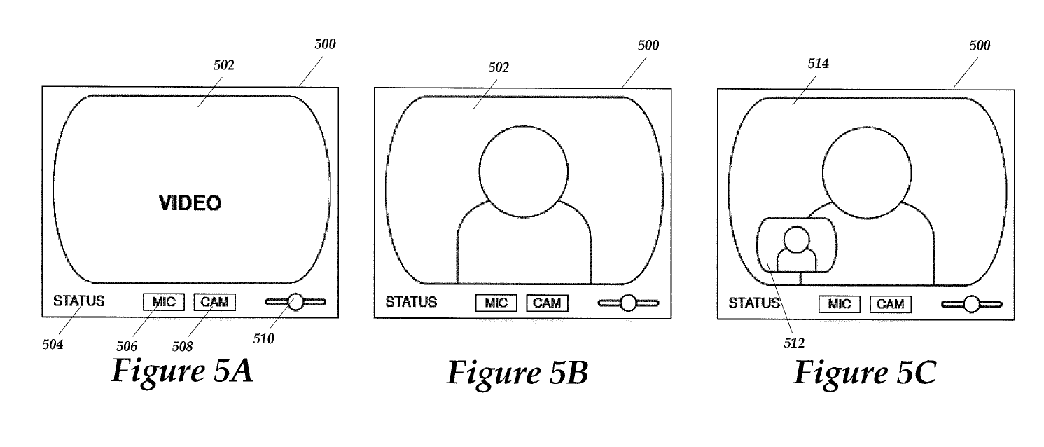

FIGS. 5A-5C depict features of a video component interface 500, under an embodiment. The interface 500 of an embodiment includes a video display 502, a status indicator 504, a mic button 506, cam button 508, and/or a volume slider 510. The status indicator 504 of one embodiment displays “SENDING”, “TWO-WAY’, and “OFF” parameters to inform a use of video communication status. The mic button 506 of an embodiment operates as microphone toggle switch that starts and stops streaming operations from a local and/or remote microphone. The cam button 508 of an embodiment operates as a video toggle switch that starts and stops streaming operations from a local and/or remote camera. The volume slider 510 of an embodiment can be used to control the audio level of the playback.

As shown in FIG. 5B, once a user connects a local camera and/or microphone, a corresponding feed is displayed on the video display 502. The interface controls can be used to adjust the camera and make any last minute changes to the user's appearance prior to sharing the video stream with another party (e.g., an invited musician). As shown in FIG. 5C, once a session invite has been sent and accepted, a video component of an embodiment renders a PIP display that includes an authoring party (e.g., authoring musician) in a smaller image display 512 and an invited party (e.g., invited musician) in the larger image display 514 (e.g., full screen background).

Again referring to FIG. 3, the chat component 306 of an embodiment can be used to provide chat features and is active when an invited user is streaming and includes an invite button that allows a user to type in a name of a desired guest or participating party. The visual sequencer component 308 of an embodiment includes a visual editor that a user can drag samples onto a timeline for snap to beat editing, but is not so limited. The visual sequencer component 308 of one embodiment enables a user to control volume, pan, mute, solo, time and/or frequency of a sample's appearance in a song or production, along with other features.

The visual sequencer component 308 of one embodiment includes, but is not limited to, the following features:

drag and drop a sample from a sound library onto an existing track;

snap a selected sample to an illustrated beat structure of a selected track;

adjust a play envelop of a sample using controls on the LEFT and/or RIGHT side of a sample object (e.g., sample adjustments can be forced to snap to a next logical beat);

render a sound wave inside of a dropped sample, wherein a backend process pre-renders a sound wave image of a selected sample and embeds the sound wave into the sample object for granular visual editing;

provide envelop markers during sample dragging operations, wherein vertical lines indicate LEFT and RIGHT edges of a selected sample during drag editing operations;

provide a track volume control allowing a user to adjust the volume with a numeric indicator (e.g., between zero and 100 percent);

provide a pan control allowing a user to adjust LEFT and RIGHT pan of a selected track, wherein a visual indicator (e.g., (−100) to (+100)) can be provided to assist the user to control pan levels;

provide a track icon, wherein each sample is assigned a sample icon based on an associated instrument category and the icon can be clicked and adjusted during editing operations;

provide volume indicators that provide a visual representation of volume levels during playback (e.g., track LEFT and RIGHT channel volume levels separately and in real or near-real time);

provide a solo feature that can be used to force a select track to play along with other Solo indicated tracks (e.g., toggling solo button “on” an “off”);

provide a mute feature to prevent a track from contributing to an overall playback (e.g., toggling a mute button “on” an “off”);

provide a record feature to arm a vocal track for recording (e.g., toggling record button “on” an “off”);

provide a time bar (e.g., vertical indicator) indicating where the playback head is queued (e.g., pressing a PLAY button will cause the bar to advance, and REWIND and FAST FORWARD controls to adjust the bar and the playback head position);

provide scrolling tracks (e.g., four (4) tracks and a vocal track);

provide filter support (e.g., five (5) preprogrammed reverb room filters);

provide equalizer (EQ) and fader support (e.g., three (3) level EQ with faders linked to a 100 Hz, 1 KHz, and 10,000 KHz, respectively); and/or,

provide track change authorization control (e.g., a two-state toggle button) to control authorization to change track data corresponding to author changes and invitee changes.

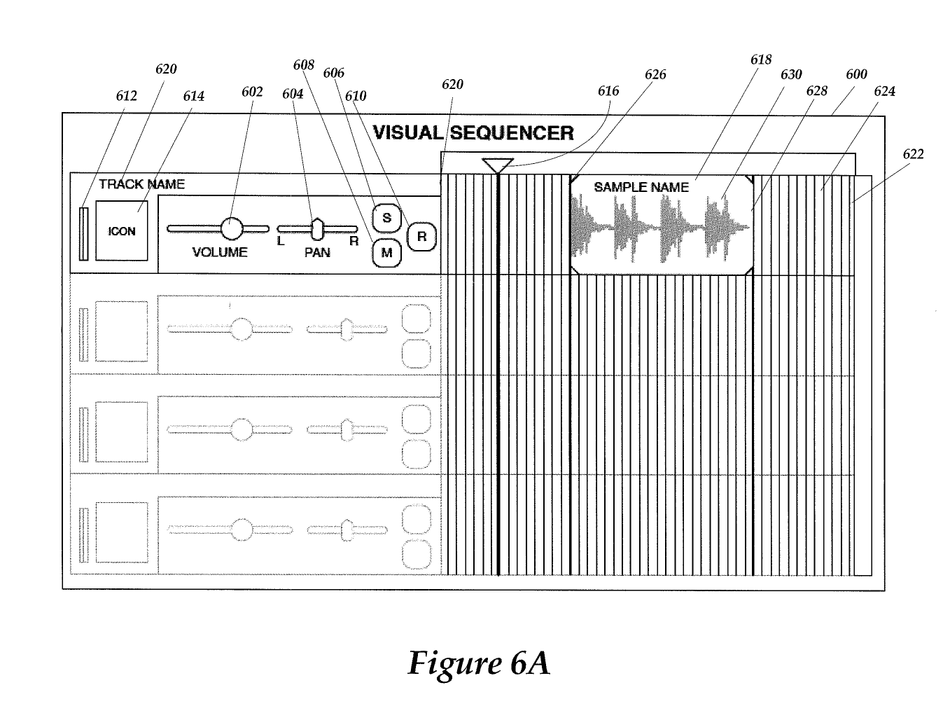

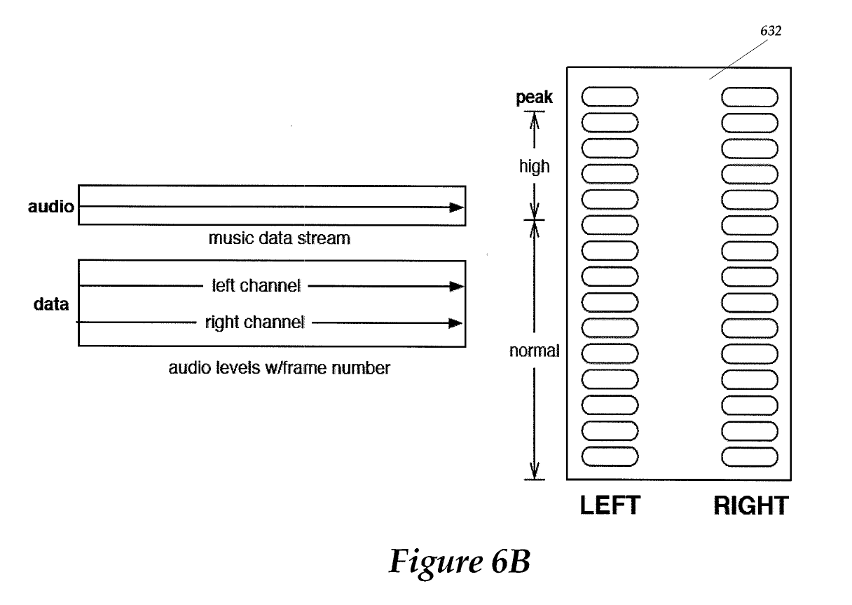

FIGS. 6A-6B depict components of an exemplary visual sequencer interface 600 including a number of interactive control components and features, under an embodiment. The interface 600 of one embodiment includes a volume control 602, a pan control 604, a solo control 606, a mute control 608, a record control 610, a volume display 612, a track icon 614, a time bar 616, and/or a track/sample display 618. A track name 620 is displayed in the interface 600 (e.g., setTrackName (trackNo, name) to set the track name).

The volume control 602 can be used to dynamically control and display track and/or sample volume changes. For example, the volume control 602 can dynamically receive volume changes and display a pop-up indicator (e.g., round rectangle) of a numeric value of a current volume level (e.g., onVolumeDrag( )). The volume control 602 of one embodiment includes a slider interface that can be used to set the track volume to values between zero (0) and one-hundred (100) (e.g., setVolume (trackNo, value)).

The pan control 604 of an embodiment can be used to dynamically control panning operations. For example, the pan control 604 can dynamically receive pan changes and display any changes inside a pop-up indicator (e.g., round rectangle) by displaying a numeric value of a current selection (e.g., onPanDrag( )). The pan control 604 of one embodiment includes a slider interface that can be used to set the track pan (e.g., setPan (trackNo, value), where max LEFT is −100 and max RIGHT is +100, centered at zero (0)).

The solo control 606 of an embodiment can be used to set the track to a solo playback state (e.g., setSolo (trackNo) having a boolean value of TRUE or FALSE). The mute control 608 of an embodiment can be used to set a track to a muted playback state (e.g., setMute (trackNo) having a boolean value of TRUE or FALSE). The record control 610 of an embodiment can be used to set a track to accept incoming data stream from a microphone when the RECORD button is actuated (e.g., armForRecord (trackNo)).

The volume display 612 of an embodiment displays right and left channel volume levels based in part on left and/or right channel data input, the volume control 602, and/or streaming microphone data (e.g., updateVolumeDisplay( )). FIG. 6B depicts an exemplary volume interface 632 that tracks and displays individual volume levels of both left and right track playback. In one embodiment, volume levels track PEAK distortion levels.

The track icon 614 of an embodiment is used to display a track or sample icon. The track icon 614 of one embodiment functions to: load a track icon from a list of options (e.g., loadTrackIcon( ) using pre-selected items), wherein the input data for the track icon 620 is driven in part by getTrackData( ); alter the icon display of the sample icon based in part on a click selection (e.g., onIconSelect( )); and/or, draw a list of available icons for a click selection (e.g., drawIconDropdown( )).

The time bar 616 of an embodiment tracks the playback head queue and is displayed over the track/sample display 618 as shown in FIG. 6. The time bar 616 of one embodiment can be altered during playback and other operations by moving the vertical time indicator (e.g., updateTimeBar( )). A user can drag the time bar 616 to the left and right within displayed sequence markers 620 and 622 (e.g., onTimeBarDrag( ), wherein extreme right or left allows for track horizontal scrolling).

The track/sample display 618 of an embodiment displays track and/or sample data including incremental beat markers 624. As shown in the example interface 600 of FIG. 6, the track/sample display 618 includes a sample 618 bounded in time by envelope or duration markers 626 and 628. In an embodiment, a sequencer component can be used to operate on samples as part of sequencer editing operations to provide a sound wave composition. For example, the sequencer component can operate to display an image of an audio wave 630 corresponding to a sample or recording on the sequencer timeline.

A sequencer component of one embodiment can provide a track/sample display 618 and:

receives a drop of a one or more samples onto a track for snapping and display (e.g., onSampleDrop (sampleID));

draws a sequence of vertical lines to indicate where beats snap to based in part on the beats per minute and overall tempo (e.g., drawBeatMarkers (bmp));

displays left and right beat duration markers to display a size of a sample (e.g., onSampleDrag (sampleID));

uses mouse movement and/or other input of a sample on a track, and snaps left start point to a corresponding beat marker (e.g., onSampleMove (sampleID));

alters a mouse or other input icon to display either an arrow, or left and/or right adjust cursors (e.g., changeMouseCursor( ));

uses input (e.g., mouse movements) on the left or right side of a sample to expand or contract an associated sound envelop and/or duration, wherein adjustments snap to beat (e.g., onSampleAdjust (sampleID));

alters the display of a sample to indicate its selection, including changing the background color and/or border width (e.g., onSampleSelect (sampleID)); and/or,

alters the display of a sample to indicate its deselection changing the background color and/or border width (e.g., onSampleDeselect (sampleID)).

Referring again to FIG. 3, the sequencer timer 310 of an embodiment visually depicts a timer of beats, bars, beats per minute, and/or overall time. The sequencer timer 310 of one embodiment can: display a Session Name; display current Bar count; display current Beat count; display current Time marker; and/or display current Beats Per Minute of one or more provided samples.

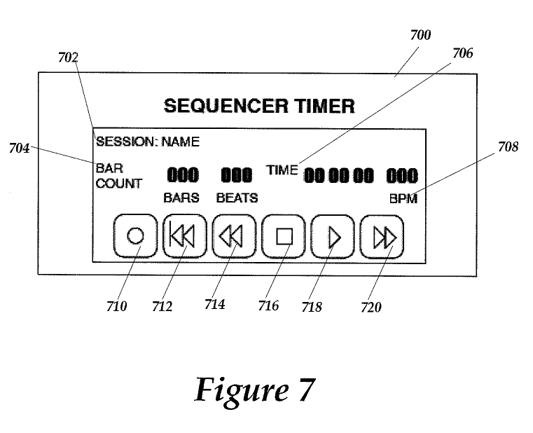

FIG. 7 depicts a sequencer time interface 700, under an embodiment. As shown in FIG. 7, the exemplary interface 700 includes a session name 702, a bar count 704 displayed as bars and beats, a time indicator 706, and/or a BPM indicator 708. The exemplary interface 700 also includes a record button 710 that stays active and can be used during live input recording and starts a local soundObject recording session (e.g., onRecord( ), a full rewind button 712 that can be used to pull the playback head to a start of a mix or other production (e.g., onFullRewind( ), a rewind button 714 that can be used to pull the playback head to a previous logical beat, wherein the button can be held down to increase a rewind increment (e.g., onRewind( )), a stop button 716 that can be used to stop all playback (e.g., onStop( )), a play button 718 that can be used to start playback from a current playhead position (e.g., onPlay()), and a fast forward button 720 that can be used to push the playback head to a next logical beat, wherein the button can be held down to increase the fast forward increment (e.g., onFastForward( )).

In one embodiment, a sequencer time interface 700 includes functionality to:

track each updating frame of time for a given soundObject or video clip and convert all relevant time to Bars, Beats, and Time (e.g., onFrameUpdate (frame));

convert a time signature to Bars (e.g., convertToBars (frame));

convert a time signature to Beats (e.g., convertToBeats (frame));

convert a time signature to Time indicating tenth of seconds, seconds, and minutes (e.g., convertToTime (frame));

update the BPM indicator for beats per minute (e.g., updateBPM (bmp)); and/or,

update the session name 702 for session name within the timer.

Bars and Beats can be calculated by dividing a minute by the BPM. Once divided, the time signature of 4/4 time can be used to determine how many beats fit in a Bar. The Bar (also referred to as a Measure) contains the Beat count as indicated by the first number in the 4/4 count signature. For example:

(60 secs/BPM)*Time Signature (ts)=Bar Size in seconds (secs)

or,

(60 secs/120 bpm)*4 ts=2 secs

(60 secs/120 bpm)=0.5 secs/Beat

The system 300 of an embodiment also includes a number of Interface Mode Selectors that include, but are not limited to: Record Vocals: Used to focus the interface on recording LIVE input device ONLY; Track Editor: Used to edit samples in the visual editor and prevent LIVE input device recording; Setup: Prompts the user to edit media player or other plug-in settings; and/or, Mix Down Mode: Prevents all recording or track editing and focuses on the user editing volume, pan, solo, mute, and overall output level.

The session controls 312 of an embodiment access stored session data and plug-in settings, but is not so limited. In one embodiment, the session controls include: a new session button that operates to create a new session with a backend or other server, which includes inserting a blank session record, and resetting an associated session interface to a default state; a load session button that operates to load an existing session into memory, restoring all track data and outward displays; a save session button that operates to write an existing session to the backend or other server, storing the settings from the user as related to an associated session; a settings button that operates to prompt a user with a control panel for making changes to audio and video settings of a plug-in (e.g., Flash, etc.); a save mixdown button that operates to direct the backend or other server to create a media file (e.g., MP3) based in part on all of the settings per track; a save as session button that operates to create a backup of an existing session into a copy session; and/or, a setup button that operates to capture all local device settings for an associated user.

The master faders component 314 of an embodiment includes slidable microphone and master controls, wherein the microphone control can be used to control input levels of one or more connected or coupled input devices (e.g., USB microphone, wireless microphone, etc.) and the master fader control can be used to control overall input levels of all tracks, samples, and/or devices.

The system 300 of an embodiment includes a synchronization component 316 including functionality that can be used to synchronize live recordings, sample data, and/or other information, but is not so limited. For example, the system 300 of one embodiment includes a synchronization component 316 that can operate to synchronize microphone and other sound data using a number of synchronization processes including, but not limited to: a prepend marking process, a reverse lookup process, an offset monitor process, and/or a supplemental process. In certain embodiments, process operations can be combined according to synchronization requirements.

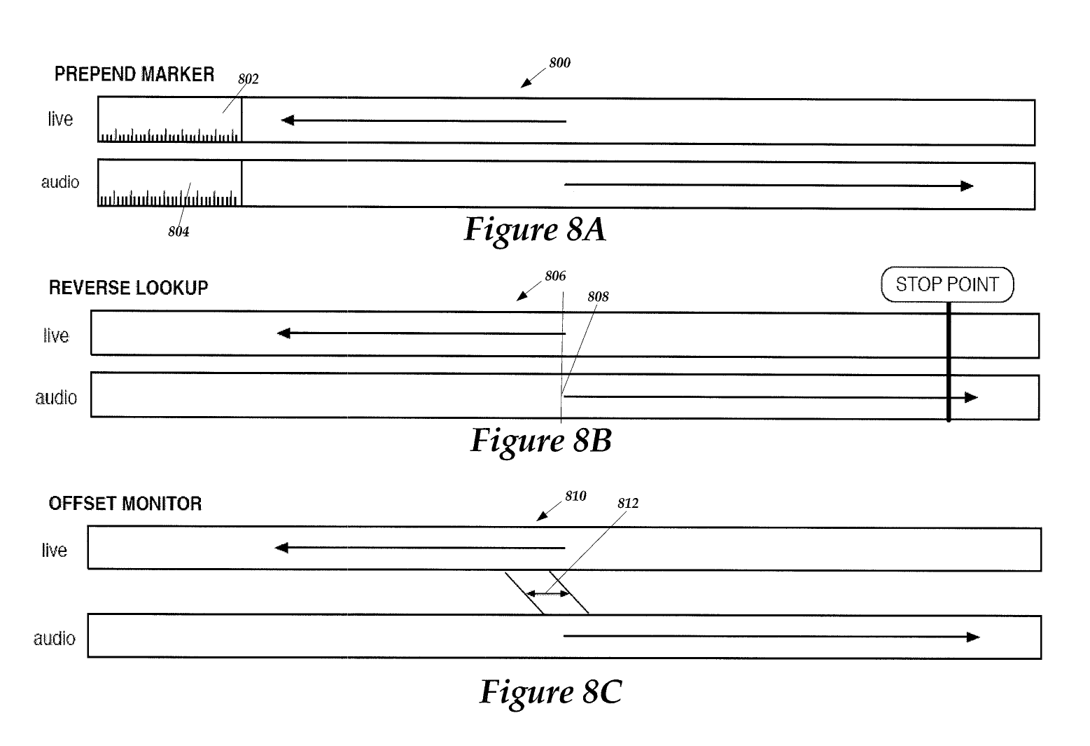

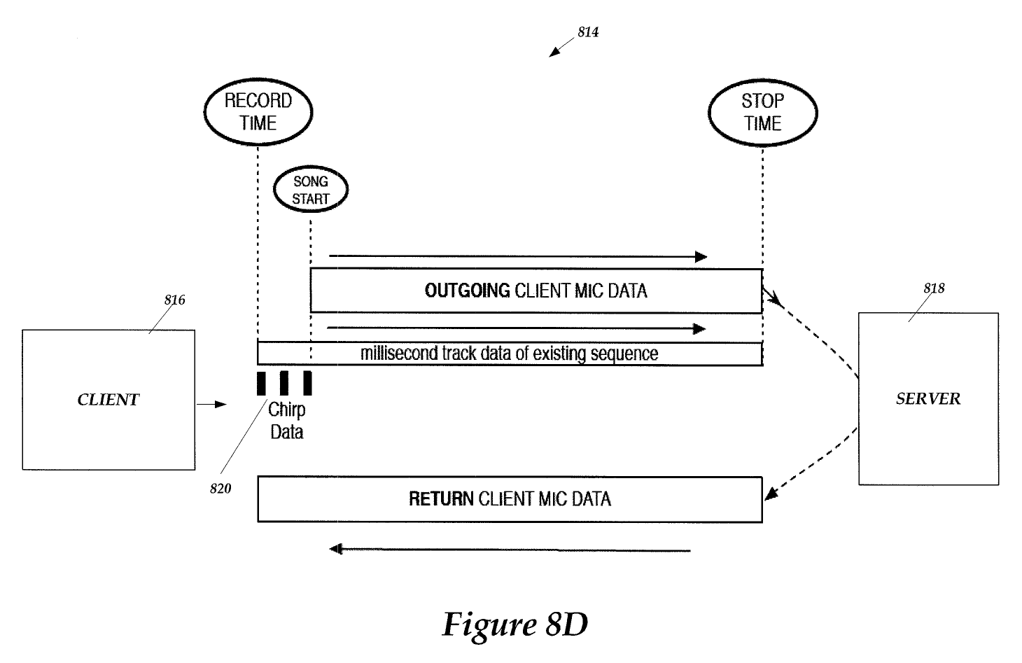

FIGS. 8A-8D depict a number of synchronization processes, under various embodiments. FIG. 8A depicts an exemplary prepend marking process 800, under an embodiment. The prepend marking process 800 of one embodiment prepends a metronome counter (e.g., counters 802 and 804) onto incoming collapsed audio so that the two signatures can be matched when the outgoing track needs to synchronize on the backend or other server.

FIG. 8B depicts an exemplary reverse lookup process 806, under an embodiment. The reverse lookup process 806 of one embodiment monitors a time signature of when a user presses the STOP button during a recording session. The corresponding time signature can be sent to the backend 808 of the incoming audio stream or playback to sew the two tracks together using the exact point that the recording was stopped.

FIG. 8C depicts an exemplary offset monitor process 810, under an embodiment. The offset monitor process 810 of one embodiment monitors a differential 812 of an outgoing stream's time signature and an incoming playback stream time signature. Once the STOP button is actuated, the differential 812 can be sent to the backend and used to adjust associated time codes of the incoming and outgoing streams.

FIG. 8D depicts an exemplary supplemental synchronization process 814, under an embodiment. The process 814 of one embodiment can be used to synchronize live sound with existing sample data by sending an outgoing mic data from a production client 816 to a stream object on a server 818. The server 818 saves a local copy of the data and sends back a stream to the client 816 for instant playback. A millisecond track can accompany the outgoing mic stream to allow the server 818 to understand where the client is during a recording operation. A prepended chirp track 820 can be added by the client 816 to assist to coordinate a recording mix of live and sampled data.

At RECORD TIME, a burst of data comprising the chirp track 820 is communicated from the client 816 to the server 818. At SONG START, another chirp of millisecond data can be communicated from the client 816 to study any latency issues that may be occurring. Such actions can be repeated by the client 816 if needed. At STOP TIME, another final message is sent from the client 816 to denote a track end. For example, a 1.5 meg Internet line should support 80 k/sec out and in to support the return data stream.

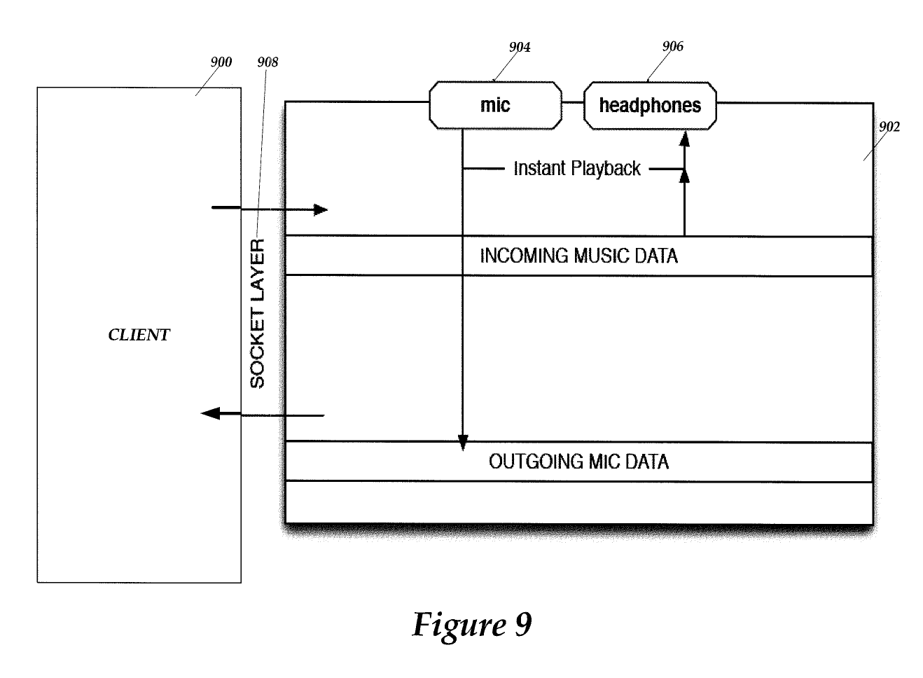

FIG. 9 depicts plugin microphone components, under an embodiment. As shown, the components include a music component 900 and a plugin component 902 that includes a microphone (mic) connection or coupling 904, and a headphone connection or coupling 906. In one embodiment, a socket layer 908 couples the music component 900 with the plugin component 902.

The plugin component 902 of one embodiment operates to provide instant playback to an output device (e.g., headset) using captured microphone data, while simultaneously playing an audio stream to the output device. The incoming microphone data can be echoed back to the music component 900 using the socket layer 908. The plugin component 902 of an embodiment synchronizes with incoming music data using a metronome count in which can be virtually played into a user's ear prior to music data playback.

The music component 900 of one embodiment operates to provide all music data for recording, wherein the data is disposable once played to a sound output device. Incoming mic data is sent to the music component 900 starting at the precise or desired time that a music track began playing. Data is not required to be instantaneous.

The embodiments include methods and systems that include a sound library component including a number of sound samples; a video component to provide video of an authoring viewer and one or more invited parties in creating a media production; a live input component to receive live input; a sequencer component to create audio tracks as part of the media production using one or more select sound samples from the sound library component and the live input, the sequencer component including one or more of a pan control, a volume control, a solo control, and a record control; and, a synchronization component to synchronize the one or more sound samples and the live input.

The embodiments described herein include and/or run under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, cellular telephones, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components of the systems described herein, and/or provided by some combination of algorithms. The methods described herein can be implemented in one or more of software algorithm(s), programs, firmware, hardware, components, circuitry, in any combination.

The components described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the systems and methods in light of the above detailed description. Accordingly, other embodiments are available.

What is claimed is:

1. A network hosted media production system comprising:
a processor and memory;
a sound library component including a number of sound samples;
a video component to provide video of an authoring viewer and one or more invited parties in creating a media production;
a live input component to receive live input;
a sequencer component to create audio tracks as part of the media production using one or more select sound samples from the sound library component and the live input, the sequencer component including one or more of a pan control, a volume control, a solo control, and a record control; and,
a synchronization component to synchronize the one or more sound samples and the live input.
